(19) United States
(12) Patent Application Publication
(10) Pub. No.: US 2007/0001606 A1
(43) Pub. Date: Jan. 4, 2007

(54) DISPLAY DEVICE, PLASMA DISPLAY PANEL AND FRONT SUBSTRATE THEREOF

(76) Inventors: Chuang-Chun Chueh, Taipei County (TW); Chao-Jun Chang, aoyuan County (TW); Chun-Hsu Lin, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,292

(22) Filed: Sep. 6, 2005

(30) Foreign Application Priority Data
Jul. 4, 2005 (TW) 94122518

(51) Int. Cl. H01J 17/49

(52) U.S. Cl. 313/583

(57) ABSTRACT

A display device including a display portion and a peripheral circuit portion is provided. The display portion includes a plurality of electrodes, and the peripheral circuit portion includes a plurality of bus electrodes and a plurality of traces. One end of each of the plurality of bus electrodes is electrically connected to a portion of the plurality of electrodes, and the other end of each of the plurality of bus electrodes is electrically connected to at least one of the plurality of traces, so as to reduce the problem due to crowded current on one of the plurality of traces and prevent the cracking on the panel during signal transmission to the plurality of electrodes by the plurality of traces.

### CROSS-REFERENCE TO RELATED APPLICATION

This application claims the priority benefit of Taiwan application serial no. 941 22518, filed on Jul. 4, 2005. All disclosure of the Taiwan application is incorporated herein by reference.

### BACKGROUND OF THE INVENTION

1. Field of the Invention

The present invention relates to a display device, and more particularly, to a display device, a plasma display panel, and a front substrate thereof capable of improving the problem due to crowded current on the trace.

2. Description of the Related Art

Along with the multimedia development, a display device, serving as a communication interface between human and computer, has played a more and more significant role now. Recently, panel display had been widely used to replace the traditional CRT (Cathode Ray Tube) display. The panel display currently used is mainly divided into following categories: Plasma display panel, Organic Electro-Luminescent Display (OELD), and Liquid Crystal Display (LCD), etc. Wherein, due to its advantageous of large size, self-emitting, no view-angle dependence, thinner and lighter, full color, and great potential in application, the plasma display panel may gradually become a mainstream product of next generation panel display.

FIG. 1 schematically shows a top view of a front substrate in a conventional plasma display panel. Referring to FIG. 1, X electrodes 102 and Y electrodes 104 are disposed on a substrate 100, and are electrically connected to a peripheral circuit of the substrate 100, respectively. Wherein, each of the X electrodes 102 is respectively electrically connected to a different voltage source, whereas all of the Y electrodes 104 are electrically connected to a bus electrode 106. All traces 108 are electrically connected to the bus electrode 106, such that a current is provided to the Y electrodes 104 via the bus electrode 106.

Generally, a plasma display panel should pass an aging test before it is sent out from the factory, the aging test is to make the emitting status of each pixel stable. Regarding the plasma display panel mentioned above, the aging testing is performed by placing a metal plate on the traces 108 first. Then, a voltage is provided onto the metal plate such that a current is provided to all of the traces 108, the bus electrode 106 and all of the Y electrodes 104. However, since the Y electrodes 104 on the band 112 are near to the trace 108a, a majority of the current is provided into the Y electrodes 104 on the band 112 via the trace 108a. In other words, a crowded current phenomenon occurs on the trace 108a, which further causes increases the temperature at the peripheral of the trace 108a on the substrate 100 and a differential temperature around the trace 108a and also other areas, which may cause cracking on the panel. It is known from physical measurement, the temperature at the peripheral of the trace 108a on the substrate 100 is about 50 to 60° C. higher than the temperature on other areas of the substrate 100, and the temperature around the trace 108a of the substrate 100 may be as higher as 109° C.

Similarly, since the Y electrodes 104 on the band 114 are near to the trace 108b, a majority of the current is provided into the Y electrodes 104 on the band 114 via the trace 108b. Accordingly, an increase in temperature may occur on the peripheral of the trace 108b on the substrate 100 due to the crowded current effect, which may further cause cracking on the panel.

### SUMMARY OF THE INVENTION

Therefore, the present invention is directed to a display device, wherein the crowded current phenomenon is suppressed.

The present invention is directed to a front substrate of a plasma display panel capable of reducing cracking on the panel during the aging test.

The present invention is directed to a plasma display panel capable of suppressing the crowded current problem therein, and providing same level of the voltage pulses onto the electrodes of each pixel so as to make the emitting status of the display stable.

As embodied and broadly described herein, the present invention provides a display device. The display device mainly comprises a display portion and a peripheral circuit portion. Wherein, the display portion comprises a plurality of electrodes and can be further divided into a plurality of bands. The peripheral circuit portion comprises a plurality of bus electrodes and a plurality of traces. One end of each of the bus electrodes is electrically connected to a portion of the electrodes that is located on one of the bands of the display portion, and the other end of each of the bus electrodes is electrically connected to one of the traces.

As embodied and broadly described herein, the present invention provides a front substrate of a plasma display panel. The front substrate of the plasma display panel mainly comprises a substrate, a plurality of electrode pairs, a plurality of bus electrodes and a plurality of traces. Wherein, the substrate comprises a display area and a peripheral circuit area and the display area can be further divided into a plurality of bands. The electrodes are disposed on the display area of the substrate, and each set of the electrode pair, for example, comprises a Y electrode and an X electrode, wherein at least one set of the electrode pair is disposed on each band of the display area. The bus electrodes are disposed in the peripheral circuit area of the substrate, wherein one end of each of the bus electrodes is electrically connected to a portion of the Y electrodes that is located on a band of the display area, and the other end of each of the bus electrodes is electrically connected to one of the traces.

As embodied and broadly described herein, the present invention provides a plasma display panel. The plasma display panel mainly comprises a rear substrate and a front substrate, which is disposed above the rear substrate. Wherein, the rear substrate comprises a first substrate, a plurality of address electrodes, a rib and a fluorescent material layer. The address electrodes and the rib are respectively disposed on the first substrate, wherein the rib is used to define a plurality of discharge spaces on the first substrate, and each of the address electrode discharge spaces is disposed on one of the discharge spaces. The fluorescent material layer is disposed on the discharge spaces and located on the address electrodes and a sidewall of the rib. The front substrate comprises a second substrate, a plurality of electrode pairs, a plurality of bus electrodes and a plurality of traces. Wherein, the second substrate comprises a display area and a peripheral circuit area, and the display area can be further divided into a plurality of bands. The electrodes pairs are disposed on the display area of the second substrate, wherein each set of the electrode pair, for example, comprises an X electrode and a Y electrode, and at least one set of electrode pair is disposed on each band of the display area. The bus electrodes are disposed on the peripheral circuit area of the second substrate, wherein one end of each of the bus electrodes is electrically connected to the Y electrodes inside an area of the display area, and the other end of each of the bus electrodes is electrically connected to one of the traces.

In accordance with an embodiment of the present invention, the resistances of the bus electrodes may be the same or different, and in the case of the resistances of the bus electrodes are not the same, the variation may be, for example, less than 10%. In an embodiment of the present invention, the bus electrode may be a trapezoid or a polygon.

In accordance with an embodiment of the present invention, the front substrate of the plasma display panel mentioned above further comprises a passivation layer, which is disposed on the substrate for covering the electrode pairs. In an embodiment of the present invention, the front substrate of the plasma display panel mentioned above further comprises a dielectric layer, which is disposed on the substrate for covering the electrode pairs, and the dielectric layer is disposed between the passivation layer and the substrate.

In accordance with an embodiment of the present invention, the plasma display panel mentioned above further comprises a first dielectric layer, which is disposed on the first substrate for covering the address electrodes, and the rib is disposed on the first dielectric layer.

In the present invention, the conventional bus electrodes are divided into a plurality of bus electrodes in order to reduce the number of the electrodes electrically connected to each of the bus electrodes, and further to reduce the amount of the current loading on each trace during the transfer of signal to the electrodes. Therefore, the problem due to crowded current on a single trace can be suppressed, and the cracking on the plasma display panel due to increasing differential temperature between the point where the current is crowded and other points can be reduced.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a top view of a front substrate in a conventional plasma display panel.

FIG. 2 schematically shows an exploded view of a plasma display panel according to an embodiment of the present invention.

FIG. 3 schematically shows a top view of a front substrate of FIG. 2 according to an embodiment of the present invention.

FIG. 4 to FIG. 7 schematically show top views of a front substrate of FIG. 2 according to some alternative embodiments of the present invention.

FIG. 5 schematically shows a top view of a front substrate of FIG. 2 according to yet another embodiment of the present invention.

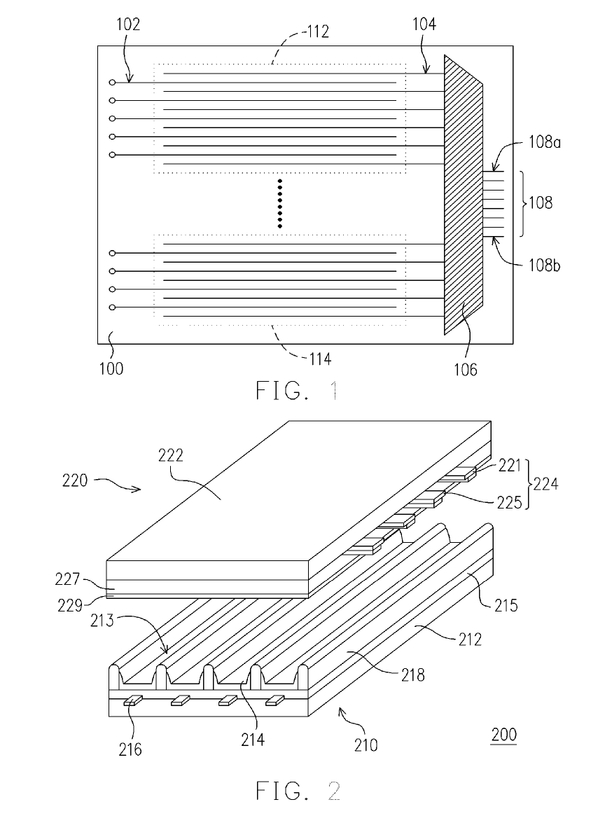

### DESCRIPTION OF EMBODIMENTS

In the present invention, the electrodes in the display portion of the display device are divided into a plurality of sets, and each set of the electrodes is electrically connected to the traces via the corresponding bus electrodes, so as to reduce the number of the electrodes electrically connected to each of the bus electrodes and further to reduce the problem of crowded current. The plasma display panel is exemplified hereinafter for description. However, the embodiment described below is for describing the present invention and the present invention is not necessarily to be limited by it. Accordingly, it will be apparent to one ordinary skill in the art that the display device of the present invention is not limited to the plasma display panel only.

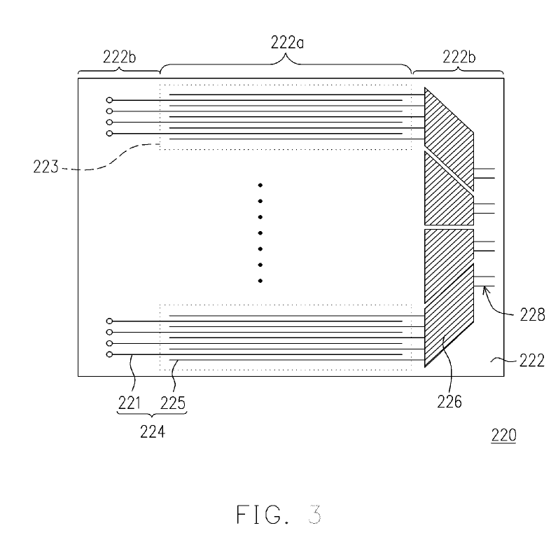

FIG. 2 schematically shows an exploded view of a plasma display panel according to an embodiment of the present invention. Referring to FIG. 2, the plasma display panel 200 comprises a rear substrate 210, a front substrate 220 and a discharge gas (not shown), which is located between the rear substrate 210 and the front substrate 220. Wherein, the rear substrate 210 comprises a first substrate 212, a plurality of address electrodes 216, a rib 218 and a fluorescent material layer 214. The address electrodes 216 disposed on the first substrate 212 are, for example, a plurality of stripe electrodes, which are disposed in parallel to each other. The rib 218 is disposed on the first substrate 212, and the rib 218, the first substrate 212, and the front substrate 220 form a plurality of discharge spaces 213. The fluorescent material layer 214 is disposed in the discharge spaces 212 and located on the address electrodes 216 and the sidewall of the rib 218. The discharge gas (not shown) is disposed in the discharge spaces 213 in order to generate plasma, and the fluorescent material layer 214 is excited by ultraviolet light emitted from plasma to emit visible light. In addition, in the present embodiment, a first dielectric layer 215 is further disposed on the first substrate 212 for covering the address electrodes 216, and the rib 218 is disposed on the first dielectric layer 215.

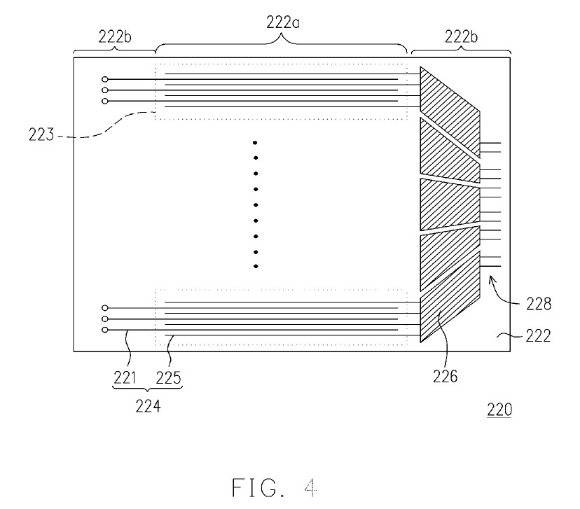

FIG. 3 schematically shows a top view of a front substrate 220 of FIG. 2. Referring to both FIG. 2 and 3, the front substrate 220 is disposed above the rear substrate 210, and the front substrate 220 comprises a second substrate 222, a plurality of electrode pairs 224, a plurality of bus electrodes 226 and a plurality of traces 228. Wherein, the second substrate 222 has a display area 222a and a peripheral circuit area 222b, and the display area 222a can be further divided into a plurality of bands. The electrode pairs 224 are disposed on the display area 222a of the second substrate 222, and each set of the electrode pairs 224 comprises an X electrode 221 and a Y electrode 225, for example. In addition, a second dielectric layer 227 and a passivation layer 229 are sequentially disposed on the second substrate 222 for covering the electrode pairs 224, such that the electrode pairs 224 can be protected and damage of the electrode pairs 224 during discharge process can be avoided. Wherein, the passivation layer 229 is made of a material such as MgO.

Referring to FIG. 3, the bus electrodes 226 are disposed in the peripheral circuit area 222b of the second substrate 222. Wherein, the bus electrodes 226 are formed through a printing process with a patterned mask. In such process, a silver paste is coated on the peripheral circuit area 222b of the second substrate 222, such that patterned bus electrodes 226 are formed. In the present embodiment, one end of each of the bus electrodes 226 is electrically connected to a portion of the Y electrode 225 that is located on a band 223 of the display area 222a, while the other end of the bus electrodes 226 is electrically connected to one or more traces 228. The signal is transmitted to the Y electrode 225, which is electrically connected to the bus electrodes 226, via the bus electrodes 226 after the signal is input from the trace 228. Thus, the plasma display panel 200 is being driven. It should be noted that the value of resistance for each of the bus electrodes 226 in the present embodiment is close to each other and the variation therebetween is less than 10%, for example. Preferably, the resistances should be equal to each other. Since the resistance of each of the bus electrodes 226 is close to each other, the present invention can effectively reduce the problem of crowded current from occurring. In other words, the currents provided into each of the electrode pairs 224 are effectively and uniformly distributed by the plurality of bus electrodes 226, such that the problem of cracking on the plasma display panel subsequent to the aging test can be further reduced.

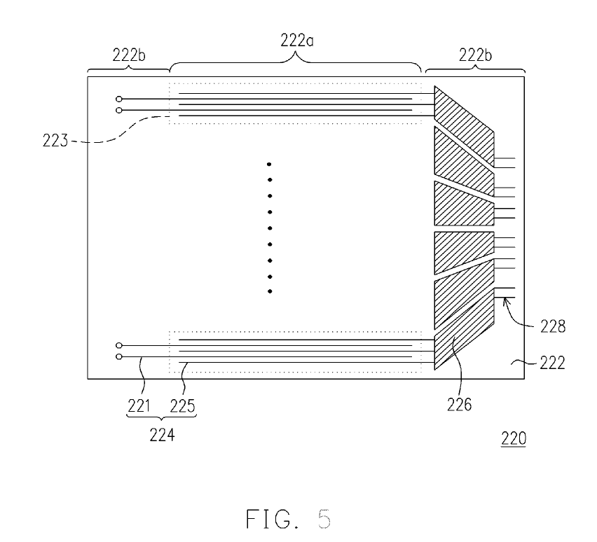

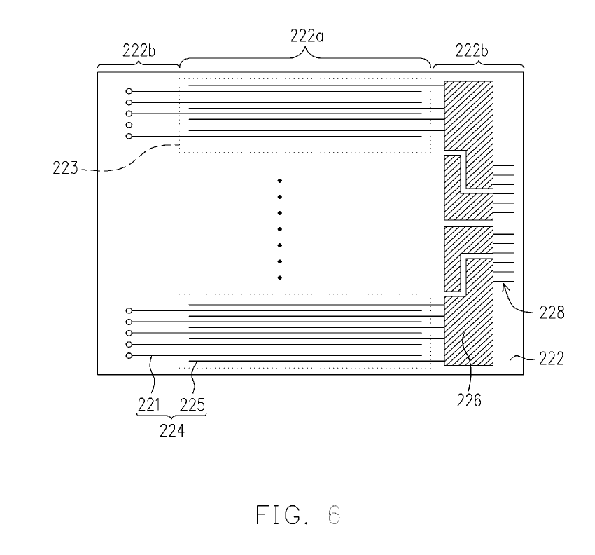

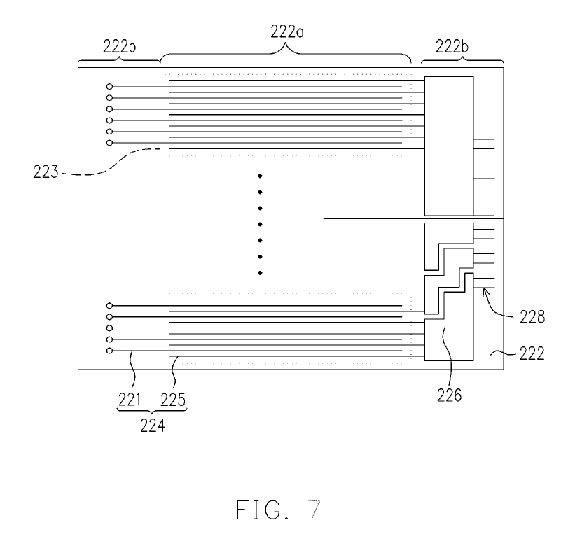

It should be noted that the number and shape of the bus electrodes 226 are not limited in the present invention. For example, the number of the bus electrodes 226 formed in the plasma display panel 200 is 4 as shown in FIG. 3. In other alternative embodiments of the present invention, the plasma display panel 20 may include 5 bus electrodes 226 (shown in FIG. 4), 6 bus electrodes 226 (shown in FIG. 5), or more bus electrodes 226 (not shown). In addition, the shape of the bus electrodes 226 is trapezoid shape as shown in FIG. 3. In other alternative embodiments of the present invention, the bus electrodes 226 can also comprise other shapes, for example, the bus electrodes 226 can be of polygon shape as shown in FIG. 6 and 7. Accordingly, one ordinary skill in the art can determine the number and shape of the bus electrodes 226 based on the real product requirement.

In summary, in the present invention, the conventional bus electrodes are divided into a plurality of bus electrodes in order to reduce the number of the electrodes electrically connected to each of the bus electrodes, and further to reduce the amount of the current loading on each trace during the transfer of signal to the electrodes. Therefore, the problem of crowded current on the single trace can be reduced, and the cracking problem due to increased differential temperature between the area where the current is crowded and other areas can be reduced.

In addition, since the values of resistance of the bus electrodes in the present invention are close to each other, its variation is less than 10% for example, such that the voltage pulse with similar level is applied onto the electrodes electrically connected to each of the bus electrodes. Therefore, the discharge of each pixel in the display device of the present invention is stable after it had passed the aging test, such that the insufficient writing problem is avoided.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A display device, comprising:
a display portion, having a plurality of electrodes, wherein the display portion is divided into a plurality of bands; and
a peripheral circuit portion, having a plurality of bus electrodes and a plurality of traces,
wherein one end of each of the bus electrodes is electrically connected to a portion of the electrodes located in one of the bands of the display portion, and the other end of each of the bus electrodes is electrically connected to at least one of the traces.

2. The display device of claim 1, wherein a differential resistance between the bus electrodes is less than 10%.

3. The display device of claim 1, wherein resistances of the bus electrodes are equal to each other.

4. The display device of claim 1, wherein a shape of the bus electrodes is trapezoid or polygon.

5. A front substrate for a plasma display panel, comprising:
a substrate, having a display area and a peripheral circuit area, wherein the display area is divided into a plurality of bands;
a plurality of electrode pairs, disposed on the display area, wherein each of the electrode pairs comprises an X electrode and a Y electrode;
a plurality of bus electrodes, disposed in the peripheral circuit area of the substrate, wherein each of the bus electrodes is electrically connected to a portion of the Y electrodes that is located on one of the bands of the display area; and
a plurality of traces, disposed on the peripheral circuit area of the substrate, wherein each of the bus electrodes is electrically connected to at least one of the traces.

6. The front substrate for the plasma display panel of claim 5, further comprising a passivation layer disposed on the substrate for covering the electrode pairs.

7. The front substrate for the plasma display panel of claim 6, further comprising a dielectric layer disposed on the substrate for covering the electrode pairs, wherein the dielectric layer is disposed between the passivation layer and the substrate.

8. The front substrate for the plasma display panel of claim 5, wherein a shape of the bus electrodes is trapezoid or polygon.

9. The front substrate for the plasma display panel of claim 5, wherein a differential resistance between the bus electrodes are less than 10%.

10. The front substrate for the plasma display panel of claim 5, wherein resistances of the bus electrodes are equal to each other.

11. A plasma display panel, comprising: a rear substrate, comprising:
a first substrate;
a plurality of address electrodes, disposed on the first substrate;
a rib, disposed on the first substrate for defining a plurality of discharge spaces, wherein each of the address electrodes is disposed on one of the discharge spaces; and
a fluorescent material layer, disposed on the discharge spaces for covering the address electrodes and a sidewall of the rib;
a front substrate, disposed above the rear substrate, comprising:
a second substrate, having a display area and a peripheral circuit area, wherein the display area is divided into a plurality of bands;
a plurality of electrode pairs, disposed on the display area of the second substrate, wherein each of the electrode pairs comprises an X electrode and a Y electrode;
a plurality of bus electrodes, disposed on the peripheral circuit area of the second substrate, wherein each of the bus electrodes is electrically connected to a portion of the Y electrodes that is located on one of the bands of the display area;
a plurality of traces, disposed in the peripheral circuit area of the second substrate, wherein each of the bus electrodes is electrically connected to at least one of the traces; and a discharge gas, disposed between the rear substrate and the front substrate and located inside the discharge spaces.

12. The plasma display panel of claim 11, further comprising a first dielectric layer disposed on the first substrate for covering the address electrodes, wherein the rib is located on the first dielectric layer.

13. The plasma display panel of claim 11, further comprising a passivation layer disposed on the second substrate for covering the electrode pairs.

14. The plasma display panel of claim 13, further comprising a second dielectric layer disposed on the second substrate for covering the electrode pairs, wherein the second dielectric layer is disposed between the passivation layer and the second substrate.

15. The plasma display panel of claim 11, wherein a differential resistance between the bus electrodes is less than 10%.

16. The plasma display panel of claim 11, wherein resistances of the bus electrodes are equal to each other.

17. The plasma display panel of claim 11, wherein a shape of the bus electrodes is trapezoid or polygon.
